(19) United States
(12) Patent Application Publication
(10) Pub. No.: US 2025/0386069 A1
(43) Pub. Date: Dec. 18, 2025

(54) INTERACTIVE VIDEO BROCHURE SYSTEM AND METHOD

(71) Applicant: Imaging Excellence 2.0 Inc., Mississauga (CA)

(72) Inventor: Scott Brockie, Mississauga (CA)

(21) Appl. No.: 18/877,804

(22) PCT Filed: Jun. 30, 2023
(86) PCT No.: PCT/CA2023/050901

§ 371 Date: Dec. 20, 2024

Related U.S. Application Data
(60) Provisional application No. 63/358,507, filed on Jul. 5, 2022.

(51) Int. Cl. H04N 21/414; G09F 19/02; H04N 21/61

(52) U.S. Cl. CPC H04N 21/41407; G09F 19/02; H04N 21/6131

(57) ABSTRACT

A video brochure, including a body printed with a print message, a display, a local data storage device, a cellular signal transmitter, and a processor. The processor is operable to retrieve a video message associated with the print message, display the video message on the display, present on the display a prompt requesting a user response, receive the user response, and send, via the cellular signal transmitter, a message based on the user response to a remote data storage device. An interactive video brochure system, including a plurality of video brochures; a remote data storage device operable to store a plurality of messages from the plurality of video brochures; and a remote processor operable to receive from a user a request identifying a selected project identifier, retrieve a set of messages each associated with the selected project identifier, and provide the user with the set of messages.

### FIELD

The specification relates generally to video brochures, and more specifically to interactive video brochures.

### BACKGROUND

United States Patent App. No. 2007/0005795 to Gonzalez (“Gonzalez”) purports to disclose a method of generating an object oriented interactive multimedia file, including encoding data comprising at least one of video, text, audio, music and/or graphics elements as a video packet stream, text packet stream, audio packet stream, music packet stream and/or graphics packet stream respectively, combining the packet streams into a single self-contained object, said object containing its own control information, placing a plurality of the objects in a data stream, and grouping one or more of the data streams in a single contiguous self-contained scene, the scene including format definition as the initial packet in a sequence of packets. Gonzalez also purports to disclose an encoder for executing the method together with a player or decoder for parsing and decoding the file, which can be wirelessly streamed to a portable computer device, such as a mobile phone or a PDA.

United States Patent App. No. 2015/0371288 to Maggio (“Maggio”) purports to disclose a system and method for providing a multi-purpose video brochure that aggregates and integrates technologies and marketing sales tools, in a single form factor, to allow a user to carry, deliver, present, and leave behind an affordable and customizable full-media sales presentation in a single stand-alone unit. Maggio purports to disclose a customizable enhanced Video Brochure solution provided in a form of a cost-effective and quickly ordered and created product. Maggio also purports to disclose a technology solution that meaningfully diminishes a number and size of individual items required to make an effective presentation to varying sizes of target audiences. Maggio also purports to disclose that a presenter of a typical group presentation is less burdened with preparing for distribution individual sets of handouts or slide presentations, and/or preparing dedicated flash drives, for example, and ensuring that appropriate (compatible) computing and projecting equipment is available in the presentation venue.

U.S. Pat. No. 10,660,222 to Hafen et al. (“Hafen”) purports to disclose systems, apparatuses, and methods for personalizing marketing materials such as video brochures. Hafen purports to disclose an electronic marketing system that includes an electronic display device powered and a housing. Hafen also purports to disclose that a window is cut into the housing which allows the electronic display to be seen through at least a portion of the housing. Hafen also purports to disclose that a second window provides a view of an insert in the housing. Hafen also purports to disclose a method for personalizing marketing materials and can include printing a custom design on an insert, cutting out at least a portion of the insert, arranging the cut out portion of the insert to show through a die cut window of the video brochure, and adhering the cut out portion of the insert to the video brochure in the arranged position.

### SUMMARY

The following summary is intended to introduce the reader to various aspects of the applicant's teaching, but not to define any invention.

According to some aspects, there is provided a video brochure, comprising: a body printed with a print message; a display secured to the body; a local data storage device secured to the body; a cellular signal transmitter secured to the body; and a processor secured to the body, the processor operable to: retrieve, from the local data storage device, a video message associated with the print message, display the video message on the display, present on the display, following displaying the video message, a prompt requesting a user response to the video message, receive the user response, and send, via the cellular signal transmitter, a message based on the user response to a remote data storage device.

In some embodiments, the body includes a plurality of panels and is foldable into a layered configuration in which each panel forms a layer of a plurality of layers, and a presentation surface of the display is covered by a panel of the plurality of panels when the body is in the layered configuration.

The video message may play in response to an unfolding of the panels, wherein unfolding the panels exposes the presentation surface of the display.

The print advertisement may include a front portion printed on a surface of the body that is outward-facing when the body is in the layered configuration.

The cellular signal transmitter may include a subscriber identity module (SIM) card.

The processor may be operable to automatically retrieve routing information identifying the remote data storage device prior to sending the message, and sending the message may include using the routing information.

The print message may be a print advertisement and the video message may be a video advertisement, and the prompt may be a request for an indication of user interest in receiving further contact regarding the print and video advertisements.

The processor may be operable to associate the indication of user interest with a project identifier prior to sending the message.

The processor may be operable to automatically retrieve routing information identifying the remote data storage device based on the project identifier and prior to sending the message, and sending the message may include using the routing information.

The prompt may request specified user contact information, and the message may be a single data packet containing the user contact information and the project identifier.

The prompt may further request a user name, and the single data packet may further contain the user name.

Presenting the prompt may include presenting a form providing an entry location for the specified user contact information.

The display may be a touchscreen, and the processor may be operable to receive the user response via the touchscreen.

According to some aspects, there is provided an interactive video brochure method, comprising: providing a video brochure to a user, the video brochure including a print message on a body of the video brochure; playing a video message on a display of the video brochure in response to a user action, the video message related to the print message; presenting, after playing the video message, the user with a prompt asking for a user response to the video message; and receiving the user response.

In some embodiments, the method is an advertising method, the print message is a print advertisement and the video message is a video advertisement, and the prompt is a request for an indication of user interest in receiving further contact regarding the print and video advertisements, and the method further comprises initiating the further contact in response to receiving the indication of user interest.

According to some aspects, there is provided an interactive video brochure system, comprising: a plurality of video brochures, each video brochure including: a body printed with a print advertisement, a touchscreen secured to the body, a local data storage device secured to the body, a signal transmitter secured to the body, and a local processor secured to the body, the local processor operable to: retrieve, from the local data storage device, a video advertisement associated with the print advertisement, display the video advertisement on the touchscreen, present on the touchscreen, following displaying the video advertisement, a prompt requesting a user response indicative of interest in the print and video advertisements, receive the user response via the touchscreen, and send, via the signal transmitter, a message based on the user response to a remote data storage device; the remote data storage device operable to store a plurality of messages from the plurality of video brochures; and a remote processor operable to: receive from a user a request identifying a selected project identifier of a plurality of project identifiers, retrieve a set of messages of the plurality of messages from the remote data storage device, each message of the set of messages associated with the selected project identifier, and provide the user with the set of messages.

In some embodiments, the body includes a plurality of panels and is foldable into a layered configuration in which each panel forms a layer of a plurality of layers, and the touchscreen is covered by a panel of the plurality of panels when the body is in the layered configuration.

The signal transmitter of each video brochure may be a cellular network transmitter and the signal transmitter of each video brochure may include a subscriber identity module (SIM) card.

The prompt may include a form, and the user response may include an entry in the form.

The local processor may be operable to associate the user response with one of the plurality of project identifiers prior to sending the message, and the message may be based on the user response and the one of the plurality of project identifiers.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is a front perspective view of a first video brochure;

FIG. 1B is a front perspective view of the video brochure of FIG. 1A in an open configuration;

FIG. 1C is a rear perspective view of the video brochure of FIG. 1A;

FIG. 2 is a schematic diagram of a video brochure system;

FIG. 3A is a rear cut-away view of a second video brochure;

FIG. 3B is a front view of the second video brochure of FIG. 3A;

FIG. 4 is a flow chart of a video brochure method;

FIG. 5 is a dashboard navigation screen;

FIG. 6 is a client module screen;

FIG. 7 is a configuration module screen;

FIG. 8 is a new configuration interface screen;

FIG. 9 is a responses received screen;

FIG. 10 is a third video brochure, showing the display exiting from a video screen to a license key entry screen; and

FIG. 11 is the video brochure of FIG. 10, showing the display exiting from the video screen to a home screen.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

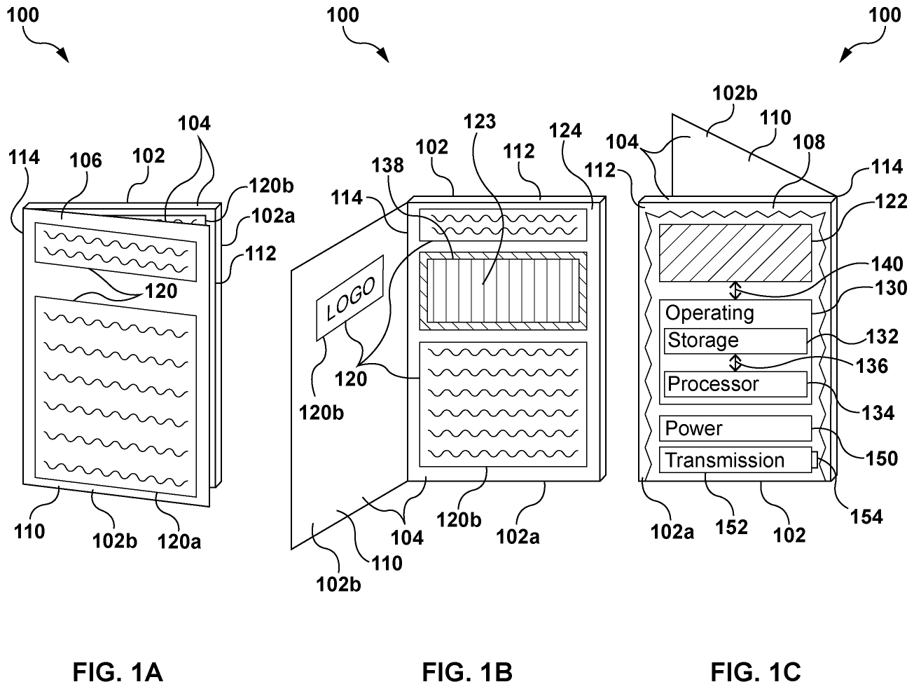

Referring to FIGS. 1A, 1B, and 1C, illustrated is an exemplary video brochure 100. The video brochure includes a body 102. The body 102 includes printable surfaces, and may include a box portion 102a and/or a sheet portion 102b. A box portion 102a accommodates electronic components, such as a video display as described further below. A sheet portion 102b provides a printable surface without requiring the full structure of a box portion 102a. A sheet portion 102b can be used to cover a surface of a box portion 102a, as illustrated. The box portion 102a and/or the sheet portion 102b may be formed of a printable paper material.

As illustrated, in some examples, the body 102 is a multi-panel body. The multi-panel body 102 includes a plurality of panels 104 (e.g., a plurality of sheets 102b, a plurality of boxes 102a, or at least one box 102a and at least one sheet 102b) and is foldable into a layered configuration, as illustrated in FIGS. 1A, in which each panel 104 forms a layer of a plurality of layers. It will be understood that in some examples, the body 102 is a single-panel body rather than a multi-layer body.

The body 102 includes a front face 106 and an opposite rear face 108 in the layered configuration. The exemplary multi-panel body 102 includes the front face 106 on a first panel 110 and the rear face 108 on a second panel 112. The exemplary first and second panels 110, 112 are joined at a fold line 114. While the exemplary body 102 includes only two panels 104, in some examples the body 102 may include more than two panels 104.

The body 102 includes a printed message 120. In some examples, the printed message 120 includes a front portion 120a printed on a surface of the body 102 that is outward-facing when the body is in the layered configuration. In some examples, the printed message 120 includes an inner portion 120b printed on a surface of the body 102 that is covered by another panel of the body 102 when the body 102 is in the layered configuration. In some examples, the printed message 120 includes the front portion 120a and the inner portion 120b.

A video display 122 is embedded within the body 102. The exemplary display 122 is secured directly to the body 102, though in some examples the display 122 may be indirectly secured to the body 102 (i.e., separated by one or more intermediate components). While the exemplary video brochure 100 includes a single display 122, in some examples the display 122 is a plurality of displays 122. The video display 122 is embedded or mounted within the box portion 102a (e.g., hidden within the body 102), with a window or cutout in a surface of the box portion 102a to reveal the presentation surface of the display 122.

It will be understood that in some examples the box portion 102a is a relatively thin flat housing having an interior space configured to house the display panel and associated electronics. For example, the box portion 102a may have a depth that is less than 20%, less than 10%, or less than 5% of the lesser of the width and the height of the box portion 102a.

The display 122 is operable to provide a user with a video message. In some examples, the video message is provided automatically without user input. In some examples, the video message is provided in response to a user action, such as opening the video brochure (e.g., to the open position of FIG. 1B) or pushing a button. In some examples, the user action is a single action (i.e., rather than a multi-part action), to encourage the user to perform the action and view the video message.

The video message is related to the printed message in some examples. In some example, the printed message 120 is a printed advertisement and the video message is a video advertisement, as described further below. For example, the printed message 120 may include a logo of a company providing the video advertisement and/or a key phrase or expression taken from the video advertisement. The printed message 120 may include contact information, disclaimers, and/or further details associated with the video advertisement.

As illustrated, in some examples the display 122 is covered by a panel of the plurality of panels 104 when the body 102 is in the layered configuration. In the exemplary embodiment, the display 122 is mounted with a presentation surface 123 directed out from a front surface 124 of the second panel 112, and the presentation surface 123 is covered by the first panel 110 when the body 102 is the layered configuration. The body 102 is opened (e.g., unfolded along fold line 114, as in FIG. 1B) to expose the presentation surface 123. However, in some examples, the presentation surface 123 is not covered by a panel 104, and is exposed without requiring a user to unfold the body 102 (e.g., a single-panel video brochure).

The video brochure 100 also includes components to operate the display 122. The components to operate the display 122 may be part of an operating system 130. The video brochure 100 includes a data storage device 132 and a processor 134 and associated electrical circuitry. The exemplary data storage device 132 and the exemplary processor 134 are each embedded in the body 102. The exemplary data storage device 132 and the exemplary processor 134 are each directly secured to the body 102, though in some examples the data storage device 132 and/or the processor 134 are indirectly secured to the body 102 (i.e., separated by one or more intermediate components). While the illustrated video brochure 100 includes a single data storage device 130 and a single processor 134, in some examples the data storage device 132 is a plurality of data storage devices 132 and/or the processor 134 is a plurality of processors 134.

The processor 134 is communicatively coupled to the data storage device 132 to retrieve information stored on the data storage device 132 and/or provide information to the data storage device 132 for storage. As exemplified, the processor 134 is communicatively coupled to the data storage device 132 via a connection 136. The connection 136 may be wired and/or wireless. While the exemplary video brochure 100 includes a single connection 136, in some examples the connection 136 is a plurality of connections 136.

The operating system 130 (e.g., the processor 134) is communicatively coupled to the display 122 to control the operations of the display 122. In some examples, the display 122 also functions as an input device 138 of the video brochure via which a user may provide a user response. For example, the display 122 may be a touchscreen. In some examples, the operating system 130 (e.g., the processor 134) is communicatively coupled to the display 122 to also receive information from the display 122 (i.e., two-way communication). As exemplified, the processor 134 is communicatively coupled to the display 122 via a connection 140. The connection 140 may be wired and/or wireless. While the exemplary video brochure 100 includes a single connection 140, in some examples the connection 140 is a plurality of connections 140.

The video brochure 100 also includes a power source 150. The exemplary power source 150 is embedded within the body 102. The exemplary power source 150 is embedded within secured directly to the body 102, though in some examples the power source 150 is indirectly secured to the body 102 (i.e., separated by one or more intermediate components). The power source 150 is coupled to the operating system 130 (e.g., to the processor 134 and the data storage device 132) and to the screen 122 to provide power. In some examples, the power source 150 is a battery, such as a lithium battery. While the illustrated video brochure 100 includes a single power source 150, in some examples the power source 150 is a plurality of power sources 150 (e.g., a battery and a capacitor).

The exemplary video brochure 100 is an interactive video brochure. In other words, the video brochure 100 is designed to interact with the user, by receiving a response from the user and making use of the user response. The processor 132 is operable to present a prompt on the display 122 requesting a user response. The prompt is presented automatically, without further involvement of the user. In some examples, the prompt is presented immediately after the video message without any intervening step or presentation on the display. In some examples, the prompt is presented within 5 seconds, 3 seconds, or 1 second of an end of the video message.

Where the print and video messages are advertising messages, the prompt is a request for an indication of user interest in receiving further contact regarding the print and video advertisements. Where the messages are not advertising messages, the prompt may request some other indication from the user. For example, if the messages are health program messages, such as daily messages to be provided to an Alzheimer's patient, the prompt may be a request for a user response that can be compared to previous user responses. For example, the prompt may request that the user complete an exercise or quiz, which is sent back automatically to a caregiver to be reviewed (e.g., compared to responses sent previously, e.g., monthly, from the Alzheimer's patient).

In some embodiments, a patient and/or a caregiver would receive a video brochure 100, and an exercise or quiz (e.g., a cognition test) is made available periodically (e.g., each month or quarter) for the patient and/or caregiver to complete. The response to the exercise or quiz can be compared with a baseline and/or one or more previous results. The video brochure 100 may include a touchscreen for ease of use. Providing the same device periodically (e.g., month after month) provides familiarity and/or ease of use. In use, in some embodiments, new questions for the exercise or quiz are automatically uploaded on the video brochure 100 when the caregiver logs in, without the caregiver needing to search for the update. The update may be automatic without any involvement of the caregiver or patient. The update may be automatic with minimal involvement of the caregiver or patient, such as only a step of authorizing the update (e.g., tapping an “authorize” soft button on the touchscreen, such as in response to a popup asking whether the next update should be loaded). Responses are sent to a server for a physician to access. In some examples, the physician is sent a notification when the response is received at the server, and provided with access to the response for the patient.

The video brochure 100 includes the input device 138. In some examples, as illustrated, the video brochure 100 includes only a single input device. In some examples, the only input device the video brochure 100 includes is the touchscreen 122. However, in some examples the input device may be another device (e.g., a keypad, microphone, or button) and/or the video brochure 100 may include a plurality of input devices (e.g., a button and a touchscreen).

In some examples, the processor 134 is operable to display a form on the display 122 to prompt the user for the user response. The form includes at least one entry location for the user to enter information (e.g., via the touchscreen). The user response may be an entry in the form. In some examples, the prompt (e.g., the form) requests specified user contact information, such a phone number, an email address, and/or a mailing address (e.g., a form including “Phone number: ______”). In some examples, the prompt requests a user name in addition or alternative to the specified user contact information.

The interactive video brochure 100 also includes a signal transmitter 152. The exemplary signal transmitter 152 is secured directly to the body 102, though in some examples the signal transmitter 152 may be indirectly secured to the body 102 (i.e., separated by one or more intermediate components). While the exemplary video brochure 100 includes a single signal transmitter 152, in some examples the signal transmitter 152 is a plurality of signal transmitters 152. The signal transmitter 152 is operable to send information to an external device. In some examples, the signal transmitter 152 is a transmission-only device, though in some examples the signal transmitter 152 is a transceiver able to receive and send signals.

In some examples, the signal transmitter 152 is a cellular signal transmitter 152. A cellular signal transmitter 152 is able to communicate directly with a cellular network with minimal or no set up on the part of the user of the video brochure 100. In contrast, other transmitters may need to be set up by a user. For example, a Wi-Fi™ transmitter may need to be coupled to a user's local wireless

Internet connection, which may involve steps (e.g., permissions) to join a Wi-Fi™ network and/or entering a network password. Cellular networks are also more available in many locations, particularly remote locations, and other networks such as Wi-Fi™ networks may not be available.

In some examples, the video brochure 100 is set up with a subscriber identity module (SIM) card 154. In some examples, the video brochure 100 (e.g., the processor 134) is operable to send information to an external device via the SIM card.

In some examples, the processor 134 is operable to associate the user response with a project identifier prior to sending the message. The project identifier identifies a project, such as an advertising campaign or health program (e.g., Alzheimer's patient monitoring program), that the user response is relevant to. In some examples, the user response (e.g., the message) is sent to an external device that handles user responses from many video brochures, with some video brochures associated with a first project and other video brochures associated with a second or further project. A project identifier allows the user responses to be retrieved based on what project they are relevant for. The project identifier may be, e.g., an alphanumeric code. Associating the user response with the project identifier includes retrieving the project identifier from the data storage device 132. In some examples, only one project identifier is stored on the data storage device 132.

In use, the processor 134 is operable to retrieve, from the data storage device 132, a video message (e.g., a video message associate with the print message 120), display the video message on the display 122, present on the display 122 a prompt requesting a user response to the video message, receive the user response, and send, via the signal transmitter 152, a message based on the user response to an external device. The external device may be or include a remote data storage device.

In some examples, the video brochure 100 (e.g., the processor 134) is operable to send information in the form of a data packet. The message may be or include the data packet. The video brochure 100 may be operable to send a single data packet containing multiple pieces of information (e.g., all relevant information contained in one data packet). In some examples, the single data packet includes the specified user contact information, the user name, and/or the project identifier.

As indicated previously, in some examples the video message plays in response to a user action. In some examples, the video message plays in response to an unfolding of the body 102. For example, the processor 134 may be operable to detect an unfolding of the body 102 (e.g., via sensor secured to the body 102, such as a pressure sensor), and, in response, retrieve the video message from the data storage deice 132 and operate the display 122 to display the video message. In some examples, the video may play in response to another user action (e.g., pushing a button or speaking a command) in addition to or as an alternative to playing in response to unfolding the body 102.

In some examples, in use the processor 134 is operable to automatically retrieve routing information identifying the external device to which the message is to be sent. Automatically retrieving routing information provides for a simpler operation of the video brochure. Simpler operation may result in more responses and/or more positive responses. For example, the routing information may be stored on the data storage device. In some examples, only one set of routing information is stored on the data storage device. In some examples, more than one set of routing information is stored on the data storage device. Sending the message may include using the routing information automatically identified by the processor. Sending the message may include sending the message to one destination server or to more than one destination server (e.g., to a first server of a company managing the brochure mailing process and to a second server of a company featured on the brochures).

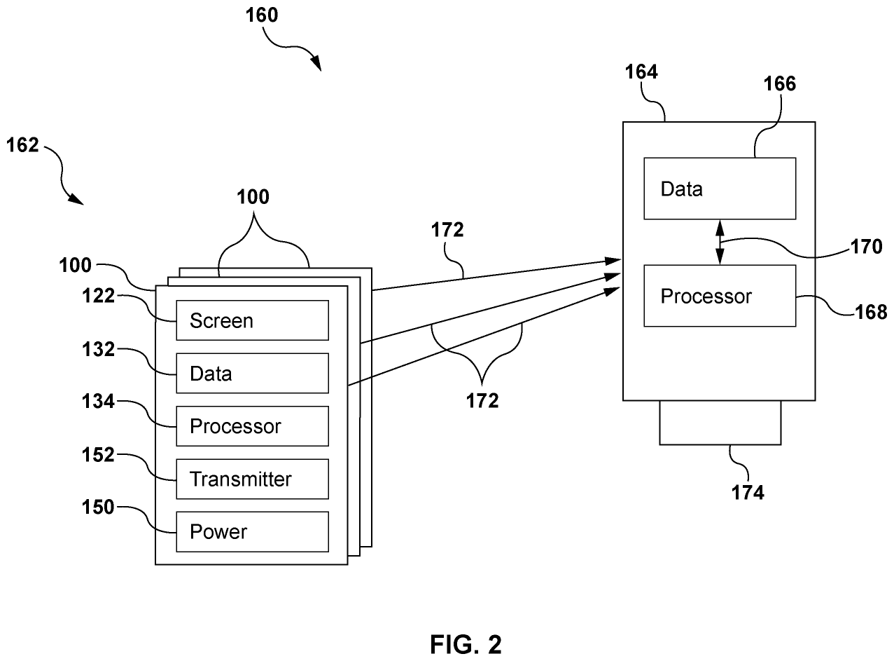

Referring now to FIG. 2, illustrated is an exemplary interactive video brochure system 160. The interactive video brochure system 160 includes a plurality 162 of the video brochures 100. The interactive video brochure system 160 also includes a remote server 164. While the illustrated system 100 includes three video brochures 100 and a single remote server 164, in some examples the plurality of video brochures 162 is more or less than three video brochures 100 and/or the remote server 164 is a plurality of remote servers 164.

The remote server 164 includes a data storage device 166 and a processer 168. While the illustrated remote server 164 includes a single data storage device 166 and a single processor 168, in some examples the data storage device 166 is a plurality of data storage devices 166 and/or the processor 168 is a plurality of processors 168. The data storage device 166 may be remote from the processor 168. The processor 168 is communicatively coupled to the data storage device 166 to retrieve information stored on the data storage device 166 and/or provide information to the data storage device 166 for storage. As exemplified, the processor 168 is communicatively coupled to the data storage device 166 via a connection 170. The connection 170 may be wired and/or wireless. While the illustrated server 164 includes a single connection 170, in some examples the connection 170 is a plurality of connections 170.

The remote server 164 is configured to receive data from the plurality of video brochures 162 (e.g., from each video brochure 100). The remote server 164 (e.g., the processor 168) is communicatively coupled to video brochures (e.g., to the processors 134 via the transmitters 152). The remote server 164 is communicatively coupled to each video brochure 100 via a connection 172. The connection 172 may be wired and/or wireless. While the illustrated system 100 includes a single connection 172 to each brochure 100, in some examples the connection 172 is a plurality of connections 172. As illustrated, in some examples the connection 172 is a one-way connection. The processor 134 is operable to send data to the remote server 164 via the transmitter 152 (e.g., a cellular transmitter). In some examples, the video brochure does not include a receiver device. In some examples, the processor 134 is not configured to receive data from the remote server 164 and/or the remote server 164 is not configured to send data to the video brochure 100.

The remote data storage device 166 is operable to store a plurality of messages from the plurality of video brochures 162. In some examples, the remote server 164 is configured for use in retrieving data associated with a single project identifier. In some examples, the remote processor 168 is operable to receive from an administrator or client user a request identifying a selected project identifier of a plurality of project identifiers. In response to the request, the processor 168 is operable to retrieve a set of messages of the plurality of messages from the remote data storage device 166, each message of the set of messages associated with the selected project identifier, and provide the administrator or client user with the set of messages. The request is input by an input device 174, which may be remote from the server 164 or at the server 164. The output from the server 164 is provided to an output device such as a display. For example, the device 174 may be a smartphone or personal computer remote from the server 164, and used by the administrator or client user to request and receive the messages.

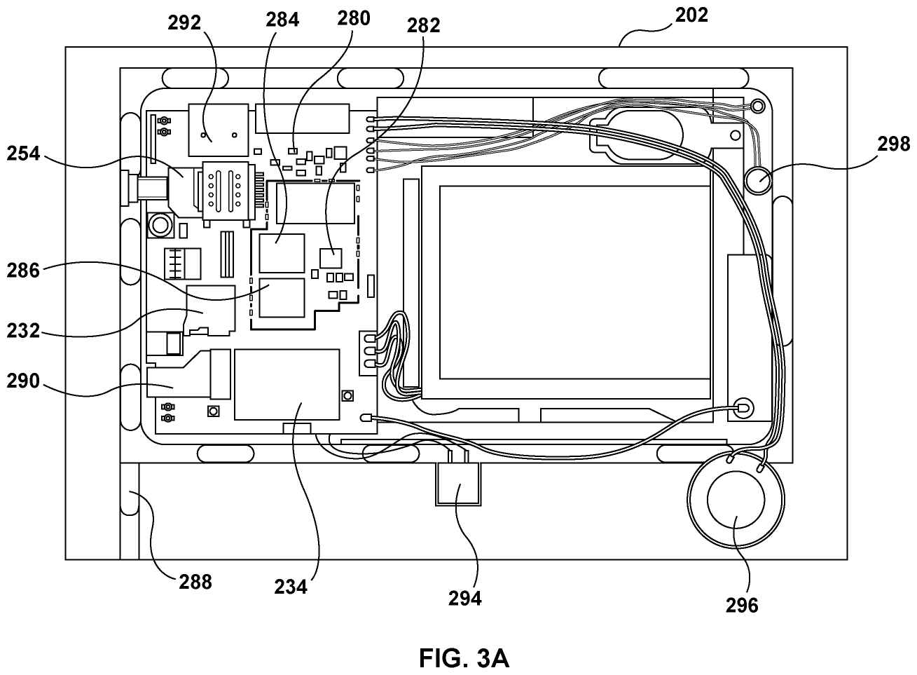

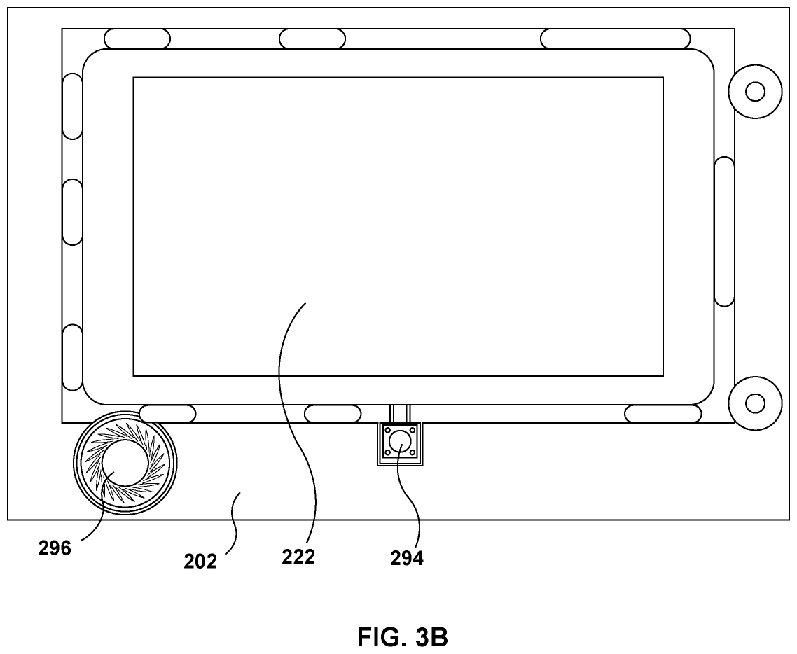

Referring now to FIGS. 3A and 3B, illustrated is a second exemplary video brochure 200. The video brochure 200 is similar in some respects to the video brochure 100, and like features are indicated by like reference numbers incremented by 100.

The exemplary video brochure 200 includes a body 202. A rear panel of the body 202 is cut away in FIG. 3A to show inside the box. The video brochure 200 includes a data storage device 232 (e.g., a TransFlash (TF) card), a processor 234 (e.g., a master control chip), a power source 250 (e.g., a lithium battery), and a SIM card 254 as part of a cellular transceiver.

The exemplary video brochure 200 also includes a motherboard 280 secured to the body 202. The video brochure 200 includes a power management integrated circuit 282 (e.g., a chip configured to handle electrical energy conversion, power distribution, power detection, and/or other power management functions in electronic equipment systems), a flash device 284 (e.g., a data storage device for storing files for later access), and a double data rate (DDR) device 286 (e.g., a Double Data Rate Synchronous Dynamic Random Access Memory; a memory for use in running software). A port 288 (e.g., a micro universal serial bus (USB) port) is provided on the video brochure 200 for coupling external devices via a wired connection to the motherboard 280. The video brochure 200 also includes a TP connecting base 290

The exemplary video brochure 200 also includes a Wi-Fi™ transceiver 292 as an alternative or complement to the cellular transceiver. It will be appreciated that playback of a video of the video brochure 200 may be triggered in any suitable way. The playback may be triggered by a physical toggle on the brochure 200, such as a button to be pressed by the user or a toggle that is triggered by a user action (e.g., opening a cover of the brochure 200). The playback may be triggered by a soft button (e.g., on a touchscreen 222). It will also be appreciated that the brochure 200 may include one or more further toggle (e.g., hard or soft toggle), such as for switching playback from a first video to a second video. As exemplified, playback is triggered by opening a cover of the brochure. As exemplified, the brochure 200 includes a button 294 is operable to be toggled to more between a first video and a second video saved on the brochure 200. The video message plays in response to toggling the button 294 from the off to the on position. The video brochure includes a speaker 296 and a vibrator 298 to assist in delivering the video message via the display.

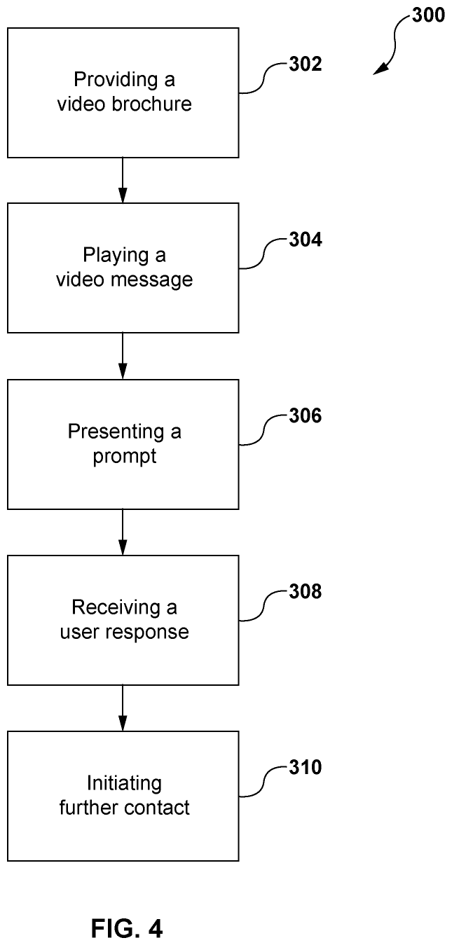

Referring now to FIG. 4, illustrated is an interactive video brochure method 300. the method 300 includes, at step 302, providing a video brochure (e.g., video brochure 100) to a user (e.g., mailing a video brochure to the user).

The video brochure includes a print message on a body of the video brochure. The user may accordingly see the print message regardless of whether they view any further feature of the video brochure. For example, if the video brochure includes a plurality of layers, even if the user does not open the video brochure they are exposed to the messages displayed on the outer surface.

The method 300 also includes, at step 304, playing a video message on a display of the video brochure in response to a user action, the video message related to the print message. The user action may be, e.g., unfolding the video brochure (i.e., lifting one panel off of another to expose the display, such as display 122 of video brochure 100). The user action may be, e.g., pushing a button (e.g., toggling a button, such as button 294 of video brochure 200). The video message relates to the print message, such as by advertising the same product and/or service or the same company.

Step 304 may be implemented automatically by a processor of the video brochure (e.g., processor 134 of brochure 100). In some examples, step 304 includes retrieving, from a local data storage device (e.g., device 132), a video message associated with the print message on the video brochure, and displaying the video message on a display of the brochure (e.g., display 122),

Method 300 also includes, at step 306, presenting, after step 304, the user with a prompt asking for a user response. For example, the prompt may be a form, such as a form presented by processor 134 on display 122. Step 306 may be implemented automatically by a processor of the video brochure (e.g., processor 134 of brochure 100). In some examples, step 306 includes presenting on the display, following step 304, a prompt requesting user response.

In some examples, method 300 includes, at step 308, receiving the user response via the video brochure. Receiving the user response provides an indication that the user is interested in the content of the video brochure. In some examples, the method 300 is an advertising method, the print message is a print advertisement, the video message is a video advertisement, and the prompt is a request for an indication of user interest in receiving further contact regarding the print and video advertisements. For example, the prompt may be a form asking the user of the video brochure to provide contact information to receive further contact regarding the print and video advertisements.

Step 308 may be implemented automatically by a processor of the video brochure (e.g., processor 134 of brochure 100). In some examples, step 308 includes receiving the user response (e.g., via the touchscreen 122), and sending, via the cellular signal transmitter, a message based on the user response to a remote data storage device (e.g., device 166). In some examples, step 308 includes automatically associating the user response with a project identifier prior to sending the message. In some examples, step 308 includes automatically retrieving routing information identifying the remote data storage device to which the message is to be sent prior to sending the message, and sending the message includes using the routing information.

In some examples, the method 300 includes, at step 310, initiating further contact in response to receiving the user response. For example, the party that sends the video brochure and receives the response (e.g., the company or individual seeking to advertise to users of the video brochure, and sending and/or receiving via a third party printing and mailing company) may follow up with a phone call, email, or further mailer to provide or seek further information. Initiating further contact with a willing user sidesteps the uncertainty of waiting for the user to take the effort to contact the provider of the video brochure.

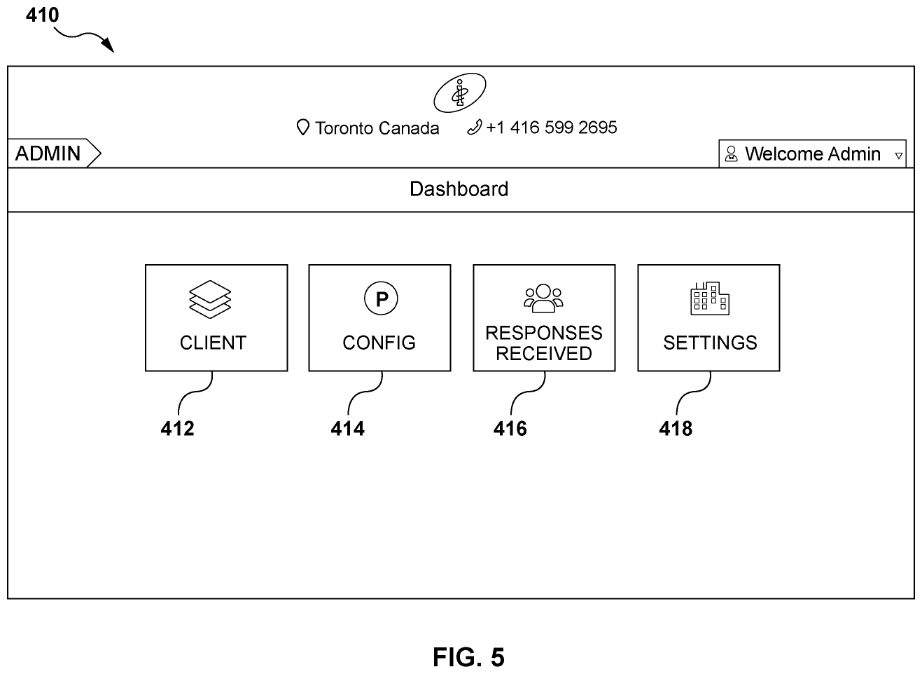

Referring now to FIGS. 5 to 11, illustrated are exemplary user interface screens that may be presented (e.g., via display 122) to a user of a video brochure system (e.g., system 160). For example, the illustrated screens may be presented by the processor 168 to an administrative user managing a project and/or a client user sending out the video brochures (e.g., the client user who hires a printing and/or mailing company to create and distribute the video brochures).

FIG. 5 illustrates an exemplary dashboard navigation screen 410. The dashboard navigation screen 410 is a screen available to administrator users. The dashboard navigation screen 410 provides a user with a client button 412, a configuration button 414, a responses received button 416, and a settings button 418.

Selecting the client button 412 provides a screen or set of screens listing all clients (i.e., individuals or companies associated as the initiator of at least one video brochure project) using the system. The screen or set of screens provided following selection of client button 412 may also allow the user to add clients, remove clients, and/or edit client information.

Selecting the configuration button 414 provides a screen or set of screens listing current configurations of the system. The screen or set of screens provided following selection of configuration button 414 may also allow the user to add video brochure configurations (i.e., layout and content), remove configurations, and/or edit configurations.

Selecting the responses received button 416 provides a screen or set of screens listing responses received from video brochures. The responses received may be organized by project and/or client.

Selecting the settings button 418 provides a screen or set of screens presenting settings options.

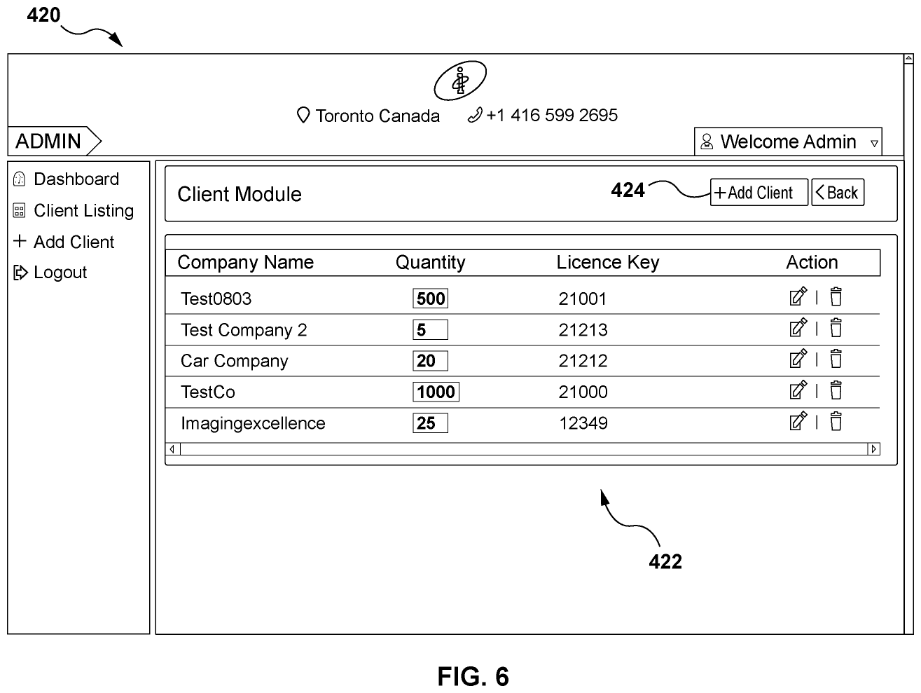

Referring to FIG. 6, illustrated is a client module screen 420. In the exemplary embodiment, selecting the client button 412 sends the user to the client module screen 420. The client module screen 420 is a screen available to administrator users. The client module screen 420 shows a listing 422 of clients, and provides an interface 424 to allow a user to add a client. To add a client, the user selects the ‘add client’ button, enters a campaign identifier, enters a client (e.g., company) name, and enters the number of brochures purchased by the client.

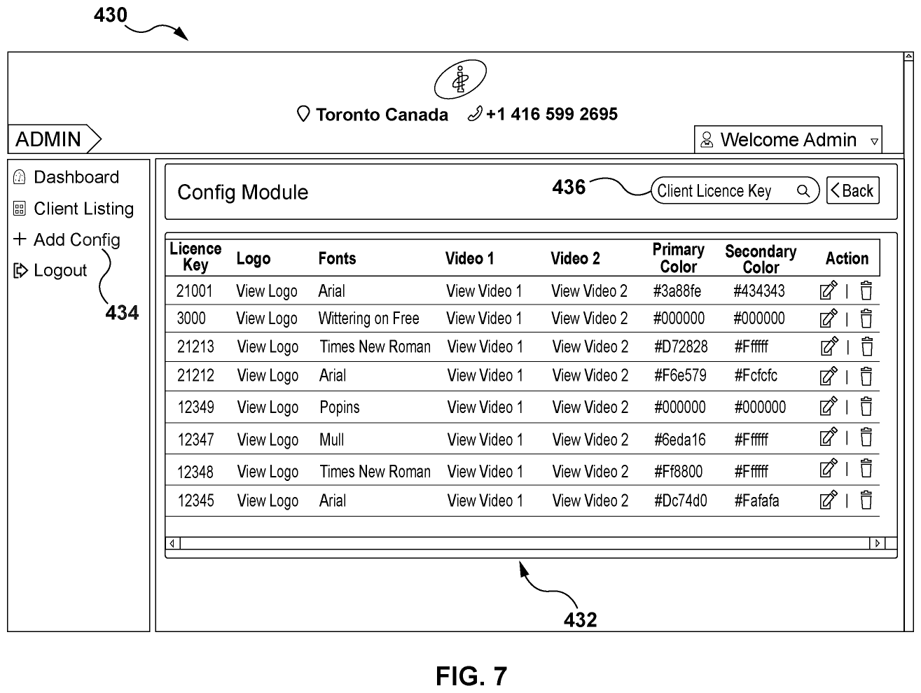

Referring to FIG. 7, illustrated is a configuration module screen 430. In the exemplary embodiment, selecting the configuration button 414 sends the user to the configuration module screen 430. The client configuration module screen 430 is a screen available to administrator users. The configuration module screen 430 shows a listing 432 of brochure configurations, allows a user to search for existing configurations by configuration identifiers (via search box 436), and provides an interface 434 to allow a user to add a new configuration. To add a configuration, the user selects the ‘add configuration’ button, and is presented with a new configuration interface.

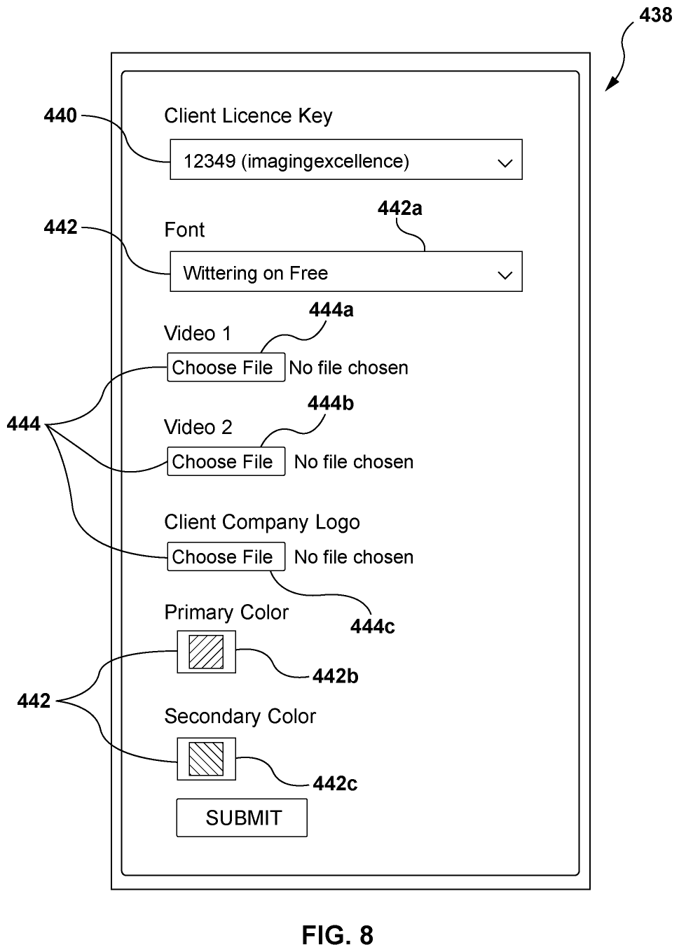

Referring to FIG. 8, illustrated is an exemplary new configuration interface 438. To create a new configuration, a user enters a project identifier that has been set up via the client module screen 420. The project identifier is entered in the identifier entry location 440. The user may enter one or more configuration formatting selection via formatting selection entry location(s) 442. The illustrated interface 438 includes a font entry location 442a, a primary color entry location 442b, and highlight color entry location 442c. The user may provide one or more content item via content item entry buttons 444. The illustrated interface 438 includes a first video upload button 444a, a second video upload button 444b, and a logo upload button 444c. For example, the configuring set up via the interface 438 may apply the logo as a printed message and load the videos as video messages to be played by a video brochure (e.g., brochure 100). In some examples, a video brochure includes only a single video. In some examples, a video brochure includes a plurality of videos loaded on the video brochure (e.g., two), and buttons or other toggles to allow the user to switch between them.

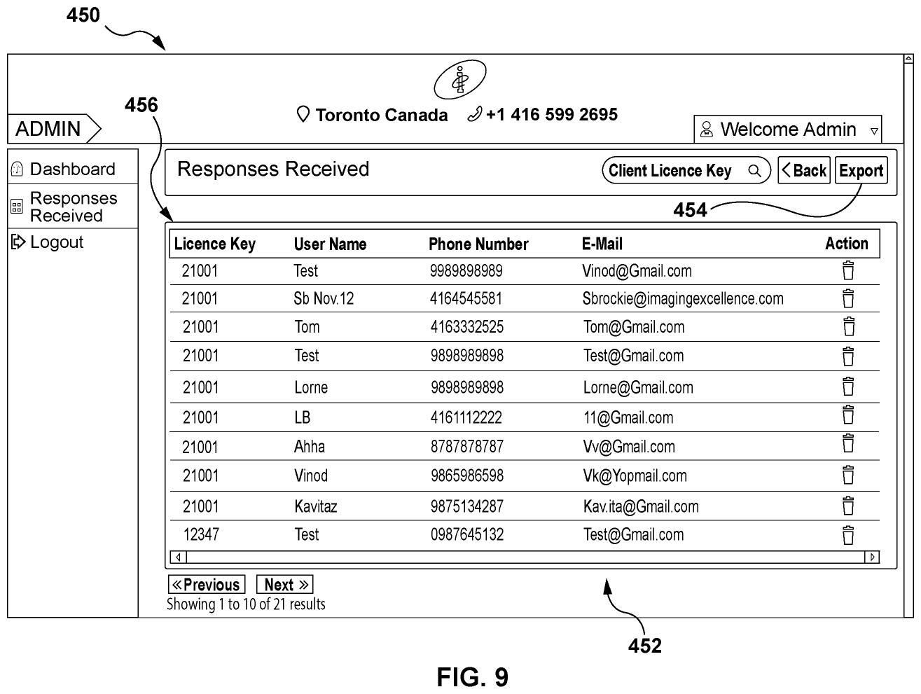

Referring to FIG. 9, illustrated is a responses received screen 450. In the exemplary embodiment, selecting the responses received button 416 sends the user to the responses received screen 450. The responses received screen 450 is a screen available to administrator users. The responses received screen 450 shows a listing 452 of responses from video brochures, and allows a user to export all and/or selected responses via an export button 454 (e.g., to an Excel file). A user is able to sort responses by project identifier 456.

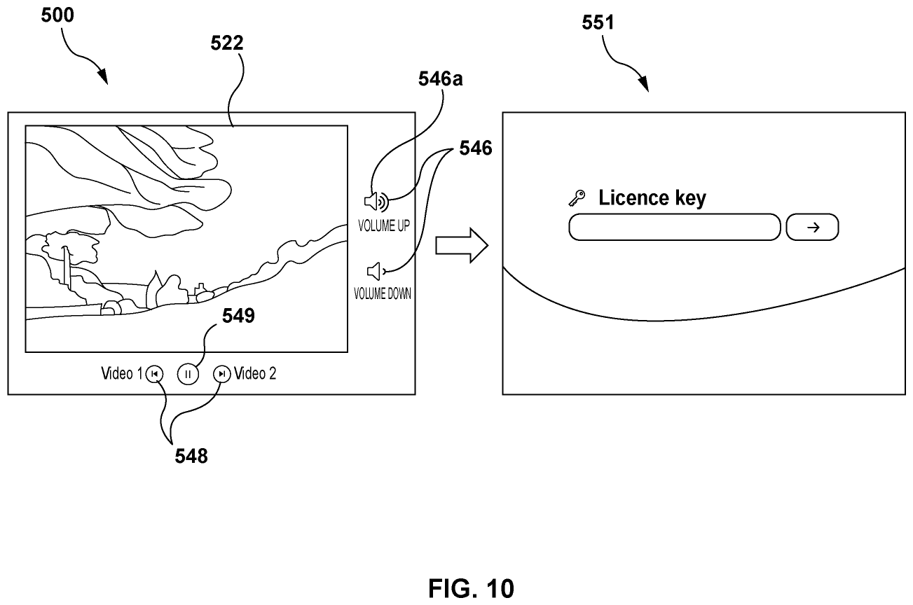

Referring now to FIG. 10, a video brochure 500 is illustrated. The video brochure 500 is similar in some respects to video brochure 100, and like features are indicated by like reference numbers incremented by 400.

The video brochure 500 includes a screen 522 and a speaker. The volume of the speaker is able to be controlled via volume buttons 546. The user is able to switch between first and second stored videos via video toggle buttons 548. A user is able to toggle between playing and pausing a video via pause button 549.

In some examples, a user is able to exit the video via manipulating one or more of the buttons 546, 548, and 549. In some examples, the user is able to exit the video by pressing and holding the volume up button 546a (e.g., holding for at least 5 seconds or at least 10 seconds). In some examples, the user is able to exit the video and pull up a License key screen 551.

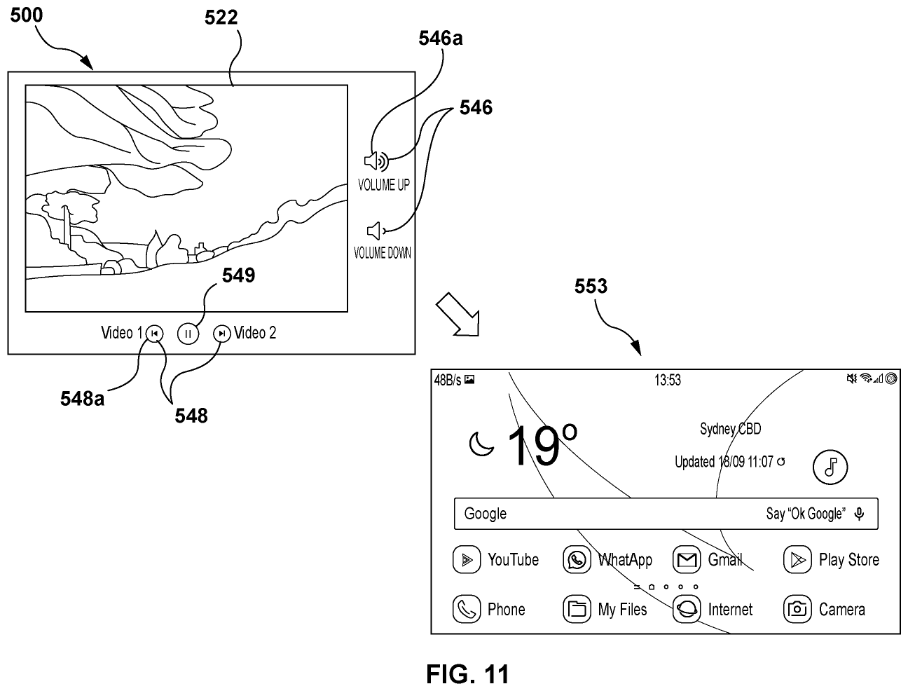

Referring now to FIG. 11, the user is able to exit the video to a different screen via a different manipulation of the buttons 546, 548, and 549. The user is able to exit the video to a device home screen 553 (e.g., an Android™ or Apple™ home screen) by pressing and holding the video back button 548a (e.g., holding for at least 5 seconds or at least 10 seconds).

While the above description provides examples of one or more apparatus, methods, or systems, it will be appreciated that other apparatus, methods, or systems may be within the scope of the claims as interpreted by one of skill in the art.

We claim:

1. A video brochure, comprising:
a) a body printed with a print message;
b) a display secured to the body;
c) a local data storage device secured to the body;
d) a cellular signal transmitter secured to the body; and
e) a processor secured to the body, the processor operable to:
i) retrieve, from the local data storage device, a video message associated with the print message,
ii) display the video message on the display,
iii) present on the display, following displaying the video message, a prompt requesting a user response to the video message,
iv) receive the user response, and
v) send, via the cellular signal transmitter, a message based on the user response to a remote data storage device.

2. The video brochure of claim 1, wherein the body includes a plurality of panels and is foldable into a layered configuration in which each panel forms a layer of a plurality of layers, and a presentation surface of the display is covered by a panel of the plurality of panels when the body is in the layered configuration.

3. The video brochure of claim 2, wherein the video message plays in response to an unfolding of the panels, wherein unfolding the panels exposes the presentation surface of the display.

4. The video brochure of claim 2, wherein the print advertisement includes a front portion printed on a surface of the body that is outward-facing when the body is in the layered configuration.

5. The video brochure of claim 1, wherein the cellular signal transmitter includes a subscriber identity module (SIM) card.

6. The video brochure of claim 1, wherein the processor is operable to automatically retrieve routing information identifying the remote data storage device prior to sending the message, and sending the message includes using the routing information.

7. The video brochure of claim 1, wherein the print message is a print advertisement and the video message is a video advertisement, and the prompt is a request for an indication of user interest in receiving further contact regarding the print and video advertisements.

8. The video brochure of claim 7, wherein the processor is operable to associate the indication of user interest with a project identifier prior to sending the message.

9. The video brochure of claim 8, wherein the processor is operable to automatically retrieve routing information identifying the remote data storage device based on the project identifier and prior to sending the message, and sending the message includes using the routing information.

10. The video brochure of claim 8, wherein the prompt requests specified user contact information, and the message is a single data packet containing the user contact information and the project identifier.

11. The video brochure of claim 10, wherein the prompt further requests a user name, and the single data packet further contains the user name.

12. The video brochure of claim 10, wherein presenting the prompt includes presenting a form providing an entry location for the specified user contact information.

13. The video brochure of claim 1, wherein the display is a touchscreen, and the processor is operable to receive the user response via the touchscreen.

14. An interactive video brochure method, comprising:
a) providing a video brochure to a user, the video brochure including a print message on a body of the video brochure;
b) playing a video message on a display of the video brochure in response to a user action, the video message related to the print message;
c) presenting, after playing the video message, the user with a prompt asking for a user response to the video message; and
d) receiving the user response.

15. The method of claim 14, wherein:
a) the method is an advertising method,
b) the print message is a print advertisement and the video message is a video advertisement, and
c) the prompt is a request for an indication of user interest in receiving further contact regarding the print and video advertisements, and
d) the method further comprises initiating the further contact in response to receiving the indication of user interest.

16. An interactive video brochure system, comprising:
a) a plurality of video brochures, each video brochure including:
i) a body printed with a print advertisement,
ii) a touchscreen secured to the body,
iii) a local data storage device secured to the body,
iv) a signal transmitter secured to the body, and
v) a local processor secured to the body, the local processor operable to:
1. retrieve, from the local data storage device, a video advertisement associated with the print advertisement,
2. display the video advertisement on the touchscreen,
3. present on the touchscreen, following displaying the video advertisement, a prompt requesting a user response indicative of interest in the print and video advertisements,
4. receive the user response via the touchscreen, and
5. send, via the signal transmitter, a message based on the user response to a remote data storage device;
b) the remote data storage device operable to store a plurality of messages from the plurality of video brochures; and
c) a remote processor operable to:
i) receive from a user a request identifying a selected project identifier of a plurality of project identifiers,
ii) retrieve a set of messages of the plurality of messages from the remote data storage device, each message of the set of messages associated with the selected project identifier, and
iii) provide the user with the set of messages.

17. The system of claim 16, wherein the body includes a plurality of panels and is foldable into a layered configuration in which each panel forms a layer of a plurality of layers, and the touchscreen is covered by a panel of the plurality of panels when the body is in the layered configuration.

18. The system of claim 16, wherein the signal transmitter of each video brochure is a cellular network transmitter and the signal transmitter of each video brochure includes a subscriber identity module (SIM) card.

19. The system of claim 16, wherein the prompt includes a form, and the user response includes an entry in the form.

20. The system of claim 16, wherein the local processor is operable to associate the user response with one of the plurality of project identifiers prior to sending the message, and the message is based on the user response and the one of the plurality of project identifiers.
